(19) United States
(12) Patent Application Publication
(10) Pub. No.: US 2011/0032658 A1
(43) Pub. Date: Feb. 10, 2011

(54) CAPACITOR ASSEMBLY AND ASSOCIATED METHOD

(75) Inventor: Rajesh V. Iyer, Eden Prairie, MN (US)

Correspondence Address: MEDTRONIC, INC., 710 MEDTRONIC PARKWAY NE, MINNEAPOLIS, MN, 55432-9924, US

(73) Assignee: Medtronic, Inc., Minneapolis, MN (US)

(21) Appl. No.: 12/537,310

(22) Filed: Aug. 7, 2009

(51) Int. Cl. H01G 4/35

(52) U.S. Cl. 361/302; 29/25.41

(57) ABSTRACT

A capacitor assembly for use in, and a method of assembling, a filtered feedthrough. The termination material present on the inner and outer diameters of the capacitor is absent from a portion of the outer diameter of the capacitor proximate an unfiltered terminal pin, such that high voltage arcing between the unfiltered terminal pin and capacitor is inhibited.

### FIELD

The present disclosure relates to a capacitor assembly and associated method of assembling a filtered feedthrough for implantable medical devices and, more particularly, to a capacitor assembly that inhibits high voltage arcing between an unfiltered feedthrough pin and a capacitor.

### INTRODUCTION

The introduction provided herein is for the purpose of generally presenting the context of the disclosure. Work of the presently named inventors, to the extent the work is described in this introduction section, as well as aspects of the description that may not otherwise qualify as prior art at the time of filing, are neither expressly nor impliedly admitted as prior art against the present disclosure.

Electrical feedthroughs serve the purpose of providing an electrical circuit path extending from the interior of a hermetically sealed container to an external point outside the container. A conductive path is provided through the feedthrough by one or more conductor pins that are electrically insulated from the container. Many feedthroughs are known in the art that provide the electrical path and seal the electrical container from its ambient environment. Such feedthroughs typically include a ferrule, one or more conductive terminal pins or leads and a hermetic ceramic seal which supports the pin(s) within the ferrule. Such feedthroughs are typically used in electrical medical devices such as implantable pulse generators (IPGs). It is known that such electrical devices can, under some circumstances, be susceptible to electromagnetic interference (EMI). At certain frequencies for example, EMI can inhibit pacing in an IPG. This problem has been addressed by incorporating a capacitor structure within the feedthrough ferrule, thus shunting any EMI at the entrance to the IPG for high frequencies. This has been accomplished with the aforementioned capacitor device by combining it with the feedthrough and incorporating it directly into the feedthrough ferrule. Typically, the capacitor electrically contacts the pin(s) and the ferrule.

Many different insulator structures and related mounting methods are known in the art for use in medical devices wherein the insulator structure also provides a hermetic seal to prevent entry of body fluids into the housing of the medical device. The feedthrough terminal pins, however, are connected to one or more lead wires which effectively act as an antenna and thus tend to collect stray or electromagnetic interference (EMI) signals for transmission to the interior of the medical device. In some prior art devices, ceramic chip capacitors are added to the internal electronics to filter and thus control the effects of such interference signals. This internal, so-called “on-board” filtering technique has potentially serious disadvantages due to intrinsic parasitic resonances of the chip capacitors and EMI radiation entering the interior of the device housing.

In another approach, a filter capacitor is combined directly with a terminal pin assembly to decouple interference signals to the housing of the medical device. In a typical construction, a coaxial feedthrough filter capacitor is connected to a feedthrough assembly to suppress and decouple undesired interference or noise transmission along a terminal pin.

So-called discoidal capacitors having two sets of electrode plates embedded in spaced relation within an insulative substrate or base typically form a ceramic monolith in such capacitors. One set of the electrode plates is electrically connected at an inner diameter surface, e.g., with a termination material, of the discoidal structure to the conductive terminal pin utilized to pass the desired electrical signal or signals. The other or second set of electrode plates is coupled, e.g., with a termination material, at an outer diameter surface of the discoidal capacitor to a cylindrical ferrule of conductive material, wherein the ferrule is electrically connected in turn to the conductive housing or case of the electronic instrument.

In operation, the discoidal capacitor permits passage of relatively low frequency electrical signals along the terminal pin, while shunting and shielding undesired interference signals of typically high frequency to the conductive housing. Feedthrough capacitors of this general type are commonly employed in implantable pacemakers, defibrillators and the like, wherein a device housing is constructed from a conductive biocompatible metal such as titanium and is electrically coupled to the feedthrough filter capacitor. The filter capacitor and terminal pin assembly prevent interference signals from entering the interior of the device housing, where such interference signals might otherwise adversely affect a desired function such as pacing or defibrillating.

In the past, feedthrough filter capacitors for heart pacemakers and the like have typically been constructed by preassembly of the discoidal capacitor with a terminal pin subassembly which includes the conductive terminal pin and ferrule. More specifically, the terminal pin subassembly is prefabricated to include one or more conductive terminal pins supported within the conductive ferrule by means of a hermetically sealed insulator ring or bead. See, for example, the terminal pin subassemblies disclosed in U.S. Pat. Nos. 3,920,888, 4,152,540; 4,421,947; and 4,424,551. The terminal pin subassembly thus defines a small annular space or gap disposed radially between the inner terminal pin and the outer ferrule. A small discoidal capacitor of appropriate size and shape is then installed into this annular space or gap, in conductive relation with the terminal pin and ferrule, e.g., by means of soldering or conductive adhesive. The thus-constructed feedthrough capacitor assembly is then mounted within an opening in the pacemaker housing, with the conductive ferrule in electrical and hermetically sealed relation in respect of the housing, shield or container of the medical device.

Although feedthrough filter capacitor assemblies of the type described above have performed in a generally satisfactory manner, such filter capacitor assemblies may be susceptible to high voltage arcing.

The present teachings provide a feedthrough filter capacitor assembly of the type used, for example, in implantable medical devices such as heart pacemakers and the like, wherein the filter capacitor is designed to inhibit high voltage arcing.

### SUMMARY

In various exemplary embodiments, the present disclosure relates to a filtered feedthrough assembly. The filtered feedthrough assembly comprises a ferrule, a capacitor arranged within the ferrule, at least one filtered terminal pin, and at least one unfiltered terminal pin. The capacitor has a top portion, a bottom portion, an outer diameter portion and an inner diameter portion. The inner diameter portion defines at least one aperture extending from the top portion to the bottom portion of the capacitor. The capacitor includes a plurality of conductive plates, with an outer diameter termination material applied to the outer diameter portion of the capacitor electrically coupling a first subset of the plurality of conductive plates and an inner diameter termination material applied to the inner diameter portion of the capacitor electrically coupling a second subset of the plurality of conductive plates. The at least one filtered terminal pin extends through the at least one aperture and is electrically coupled to the inner diameter portion of the capacitor. The at least one unfiltered terminal pin extends through the ferrule. The outer diameter portion of the capacitor includes an unterminated portion proximate the at least one unfiltered terminal pin.

In further various exemplary embodiments, the present disclosure relates to a method of assembling a filtered feedthrough assembly. The method comprises providing a capacitor, inserting at least one filtered terminal pin and at least one unfiltered terminal pin within a ferrule, and fixedly securing the capacitor within the ferrule. The capacitor has a top portion, a bottom portion, an outer diameter portion and an inner diameter portion. The inner diameter portion defines at least one aperture extending from the top portion to the bottom portion of the capacitor. The capacitor includes a plurality of conductive plates, with an outer diameter termination material applied to the outer diameter portion of the capacitor electrically coupling a first subset of the plurality of conductive plates and an inner diameter termination material applied to the inner diameter portion of the capacitor electrically coupling a second subset of the plurality of conductive plates. The outer diameter termination material is absent from an unterminated portion of the outer diameter portion of the capacitor. The at least one filtered terminal pin extends through the at least one aperture and is electrically coupled to the inner diameter portion of the capacitor. Further, the at least one unfiltered terminal pin extends through the ferrule proximate to the unterminated portion of the outer diameter portion of the capacitor.

In further various exemplary embodiments, the present disclosure relates to a capacitor assembly for use in a filtered feedthrough for an implantable medical device. The capacitor has a top portion, a bottom portion, an outer diameter portion and an inner diameter portion. The inner diameter portion defines at least one aperture extending from the top portion to the bottom portion of the capacitor. The capacitor includes a plurality of conductive plates, with an outer diameter termination material applied to the outer diameter portion of the capacitor electrically coupling a first subset of the plurality of conductive plates and an inner diameter termination material applied to the inner diameter portion of the capacitor electrically coupling a second subset of the plurality of conductive plates. The outer diameter termination material is absent from an unterminated portion of the outer diameter portion of the capacitor. The unterminated portion of the outer diameter portion of the capacitor is coated with a non-conductive coating.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF DRAWINGS

The present disclosure will become more fully understood from the detailed description and the accompanying drawings, wherein:

FIGS. 1 and 2 are isometric and cross-sectional views, respectively, of a known unipolar (single pin) feedthrough assembly prior to attachment of a discrete discoidal capacitor;

FIGS. 3-5 illustrate a prior art method of attaching a discrete discoidal capacitor to the feedthrough assembly shown in FIGS. 1 and 2;

FIG. 6 is a cross-sectional view of a discrete discoidal capacitor for use in a known unipolar (single pin) feedthrough assembly;

FIGS. 7 and 8 are exploded and cross-sectional views, respectively, of a multipolar (multiple pin) filtered feedthrough assembly illustrating the attachment of a monolithic discoidal capacitor in accordance with various exemplary embodiments of the present disclosure;

FIG. 9 is a perspective view of a capacitor according to various embodiments of the present disclosure;

FIG. 10 is a top view of the capacitor of FIG. 9;

FIG. 11 is a cross-sectional view of the capacitor of FIG. 10 taken along line 11-11;

FIG. 12 is a further cross-sectional view of the capacitor of FIG. 10 taken along line 11 -11 illustrating additional features;

FIG. 13 is a perspective view of a partially disassembled implantable medical device; and

FIG. 14 is an isometric cutaway view of an implantable medical device incorporating the multipolar (multiple pin) filtered feedthrough assembly of FIG. 7.

### DESCRIPTION

The following description is merely exemplary in nature and is in no way intended to limit the disclosure, its application, or uses. For purposes of clarity, the same reference numbers will be used in the drawings to identify similar elements. As used herein, the phrase at least one of A, B, and C should be construed to mean a logical (A or B or C), using a non-exclusive logical or. It should be understood that steps within a method can be executed in different order without altering the principles of the present disclosure.

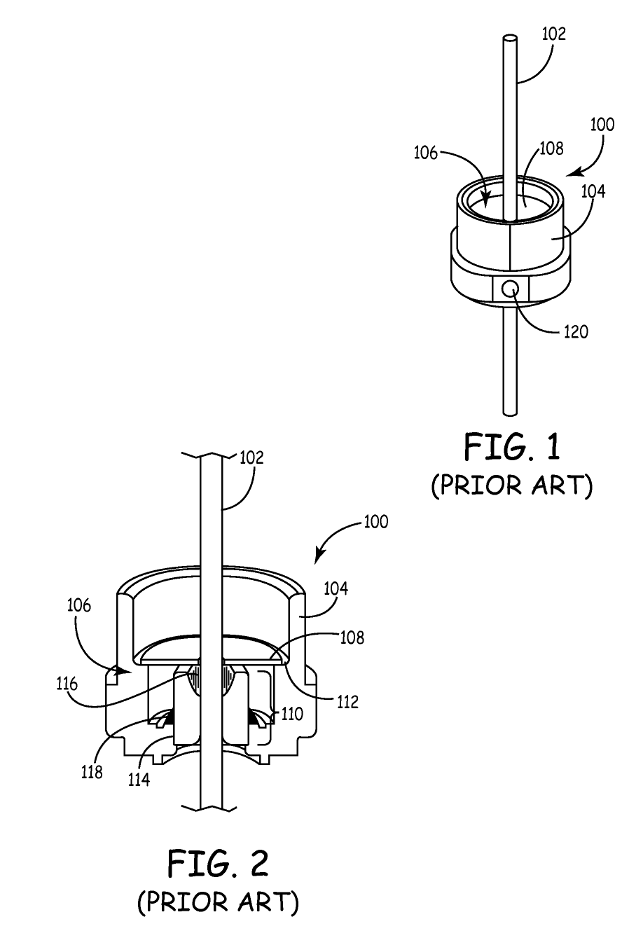

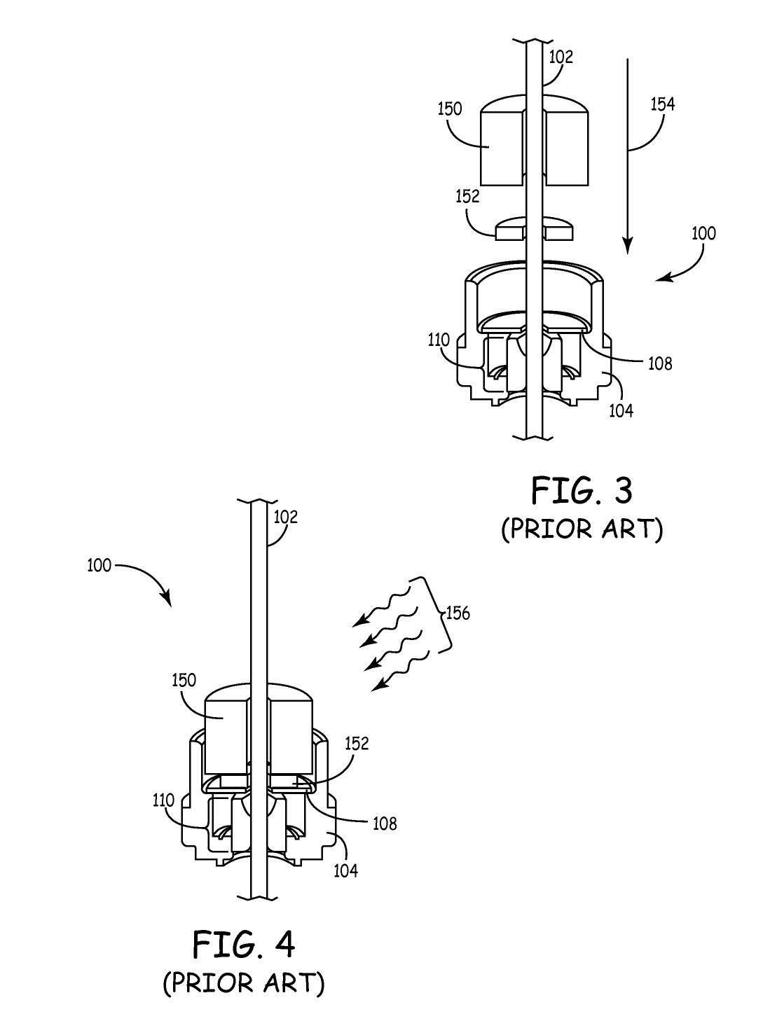

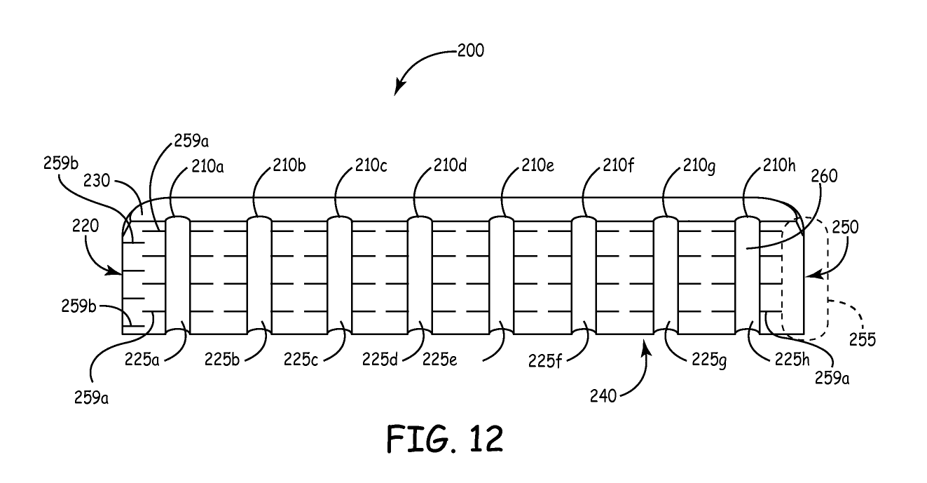

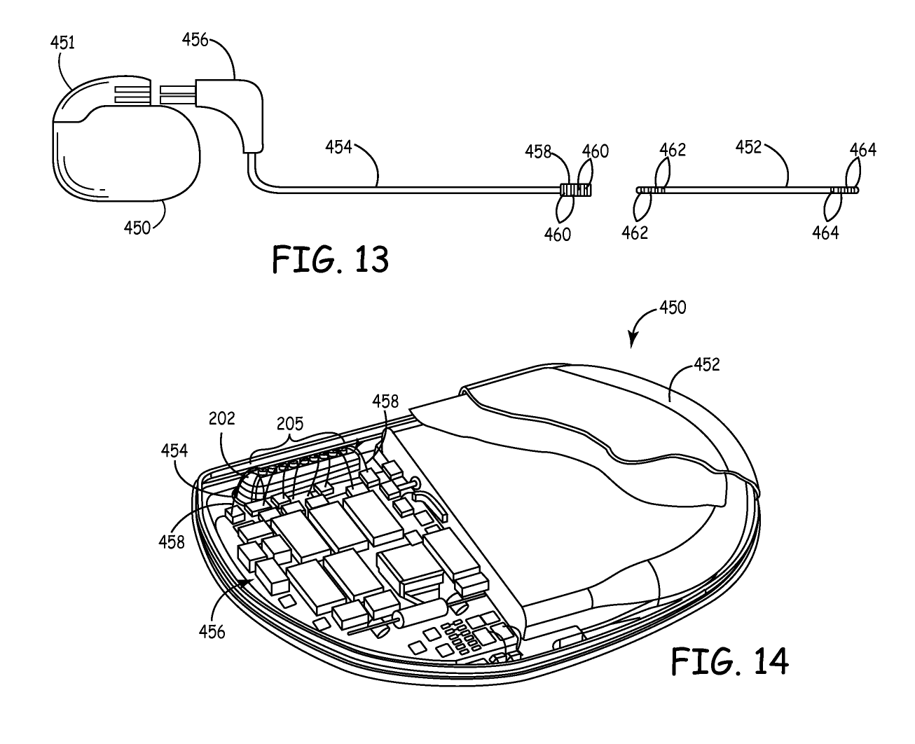

FIGS. 1 and 2 are isometric and cross-sectional views, respectively, of a known unipolar (single pin) feedthrough assembly 100 having a terminal pin 102 extending therethrough. Assembly 100 comprises a generally cylindrical ferrule 104 having a cavity through which pin 102 passes. Ferrule 104 is made of an electrically conductive material (e.g., titanium alloy) and is configured to be fixedly coupled (e.g., welded) to the container of a medical device as described below in conjunction with FIGS. 13-14. An insulating structure 106 is disposed within ferrule 104 to secure pin 102 relative to ferrule 104 and to electrically isolate pin 102 from ferrule 104. Insulating structure 106 comprises a supporting structure 108 and a joint-insulator sub-assembly 110, both of which are disposed around terminal pin 102. As will be more fully described below, joint-insulator sub-assembly 110 acts as an insulative seal and can take the form of, for example, a braze joint. Supporting structure 108 is made of a non-conductive material (e.g., polyimide) and rests on an inner ledge 112 provided within ferrule 104. As will be seen in FIG. 3, a discrete discoidal capacitor 150 can be threaded over terminal pin 102 and fixedly coupled to supporting structure 108 to attach the capacitor to feedthrough assembly 100.

As can be seen in FIG. 2, braze joint 110 comprises three main components: an insulating ring 114 (e.g., made from a ceramic material) that insulates pin 102 from ferrule 104, a pin-insulator braze 116 (e.g., made from gold) that couples insulating ring 114 to pin 102, and an insulator-ferrule braze 118 (e.g., made from gold) that couples insulating ring 114 to ferrule 104. Braze joint 110 is exposed along the underside of ferrule 104. When ferrule 104 is fixedly coupled to the container of the medical device, the lower portion of ferrule 104, and thus the lower portion of braze joint 110, can be exposed to body fluids. For this reason, it is important that braze joint 110 forms a hermetic seal between ferrule 104 and terminal pin 102. Braze joint 110 can be leak tested. To permit this test to be performed, an aperture 120 (FIG. 1) is provided through ferrule 104 to the inner annular cavity formed by the outer surface of braze joint 110, the lower surface of supporting structure 108, and the inner surface of ferrule 104. A gas is delivered through aperture 120 into the inner annular cavity, and aperture 120 is plugged. Preferably, a gas of low molecular weight (e.g., helium or hydrogen) is chosen so that it can easily penetrate small cracks in braze joint 110. Feedthrough 100 is then monitored for the presence of the gas proximate braze joint 110 by way of, for example, a mass spectrometer. If no gas is detected, it is concluded that braze joint 110 has formed a satisfactory seal.

Terminal pin 102 provides a conductive path from the interior of a medical device (not shown) to one or more lead wires exterior to the medical device. As described previously, these lead wires are known to act as antennae that collect stray electromagnetic interference (EMI) signals, which can interfere with the proper operation of the device. To suppress and/or transfer such EMI signals to the container of the medical device, a discrete discoidal capacitor can be attached to feedthrough assembly 100. In particular, the capacitor can be disposed around and electrically coupled to terminal pin 102 and fixedly coupled to supporting structure 108. FIGS. 3-5 illustrate a known manner of attaching a discrete discoidal capacitor 150 to feedthrough assembly 100 shown in FIGS. 1 and 2. The attachment method commences as a ring-shaped preform 152 of non-conductive epoxy is threaded over terminal pin 102 (indicated in FIG. 3 by arrow 154). Capacitor 150 is then threaded over pin 102 and positioned against preform 152 such that preform 152 is sandwiched between capacitor 150 and supporting structure 108. Next, feedthrough assembly 100 is placed within a curing oven and heated to a predetermined temperature (e.g., approximately 175 degrees Celsius) to thermally cure preform 152 (indicated in FIG. 4 by arrows 156) and thus physically couple capacitor 150 to supporting structure 108.

During curing, preform 152 melts and disperses under the weight of capacitor 150, which moves downward toward supporting structure 108. Preform 152 disperses along the annular space provided between the bottom surface of capacitor 150 and the upper surface of supporting structure 108 to physically couple capacitor 150 and supporting structure 108 as described above.

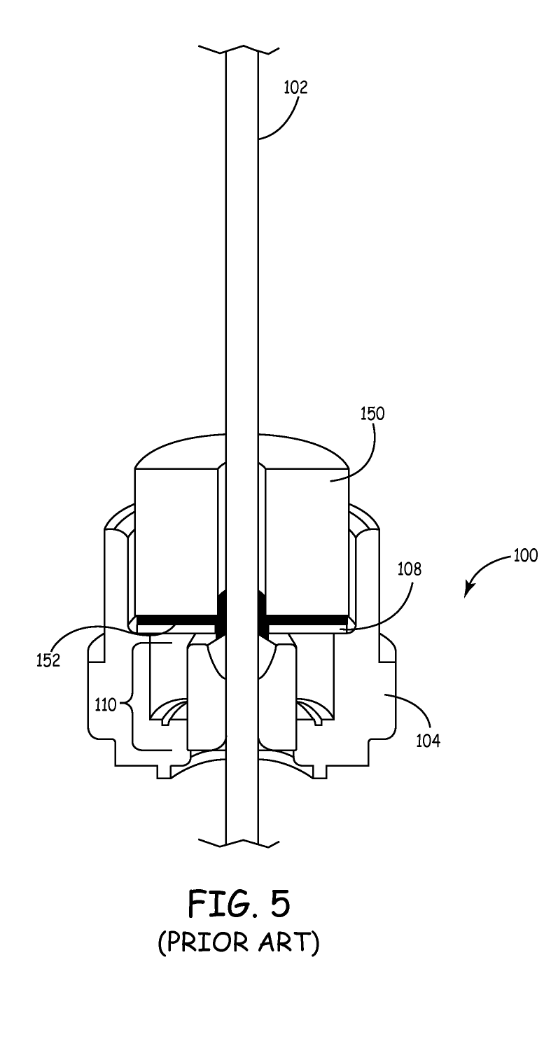

FIG. 6 illustrates a known discrete discoidal capacitor 150, such as that utilized in feedthrough assembly 100. Capacitor 150 includes a top portion 151, a bottom portion 153, an outer diameter portion 155 and an inner diameter portion 157. The inner diameter portion 157 defines at least one aperture 165 extending from the top portion 151 to the bottom portion 153 of capacitor 150. Capacitor 150 can take the form of a discoidal capacitor having two sets of electrode plates 159a, 159b embedded in spaced relation within an insulative substrate or base. One set of the electrode plates 159a is electrically connected to an inner diameter portion 157, e.g., with a termination material. The other or second set of electrode plates 159b is electrically coupled, e.g., with a termination material, to an outer diameter portion 155 of the discoidal capacitor 150.

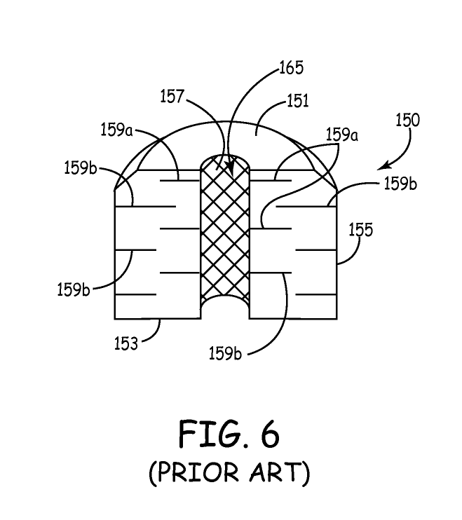

FIGS. 7 and 8 illustrate the attachment of a monolithic discoidal capacitor 200 to a multipolar feedthrough assembly 202 in accordance with a various exemplary embodiments of the present invention. Filtered feedthrough assembly 202 comprises a ferrule 206 and an insulating structure 204 disposed within ferrule 206. Insulating structure 204 is similar to insulating structure 106 described above. Filtered feedthrough assembly 202 guides an array of terminal pins 205 through the container of a medical device to which ferrule 206 is coupled (shown in FIG. 13). As described above, terminal pin array 205 and the lead wires to which array 205 is coupled may act as an antenna and collect undesirable EMI signals. Monolithic discoidal capacitor 200 may be attached to feedthrough assembly 202 to provide EMI filtering. Capacitor 200 is provided with a plurality of terminal pin-receiving apertures 210 therethrough. Capacitor 200 is inserted over terminal pin array 205 such that each pin in array 205 is received by a different aperture 210 and placed in an abutting relationship with insulating structure 204. If desired, one terminal pin 205U in array 205 may be left unfiltered to serve as an RF antenna. Support structure 280 can be provided between insulating structure 204 and capacitor 200. Capacitor 200 can be coupled to support structure 280, such as by projections 281 on support structure 280 being securely received within terminal pin-receiving apertures 210. Furthermore, a sleeve 282 may be included on support structure 280 to assist in the isolation of the unfiltered terminal pin 205U from capacitor 200.

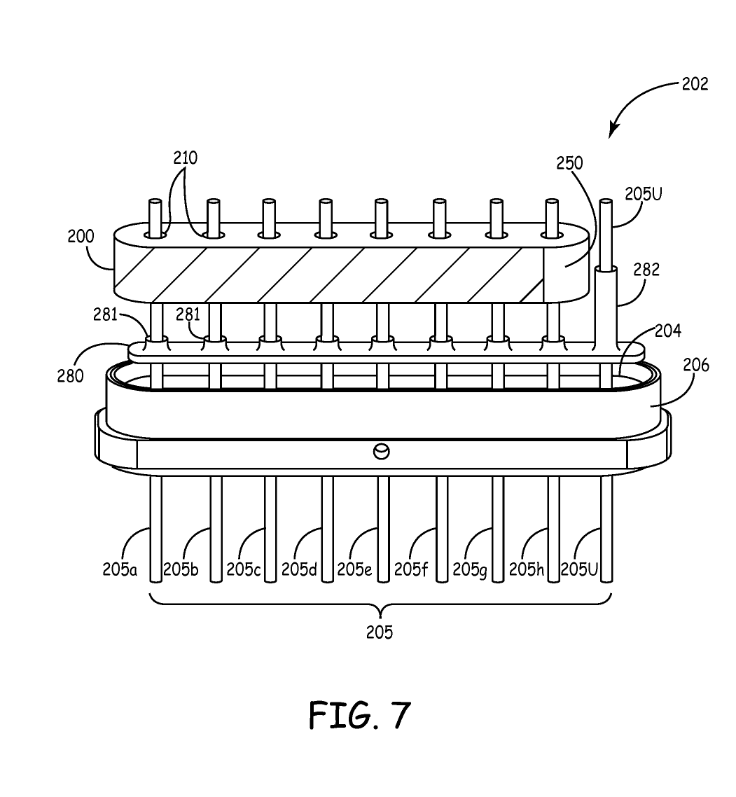

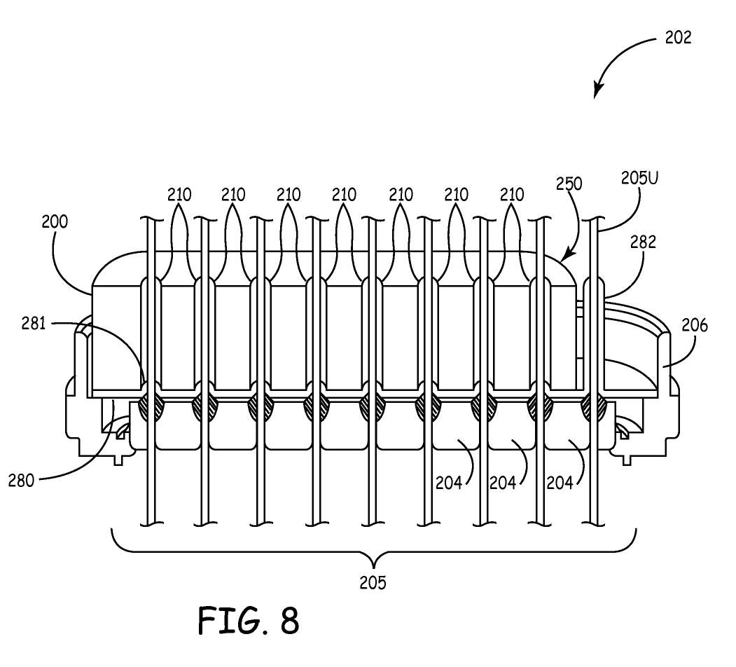

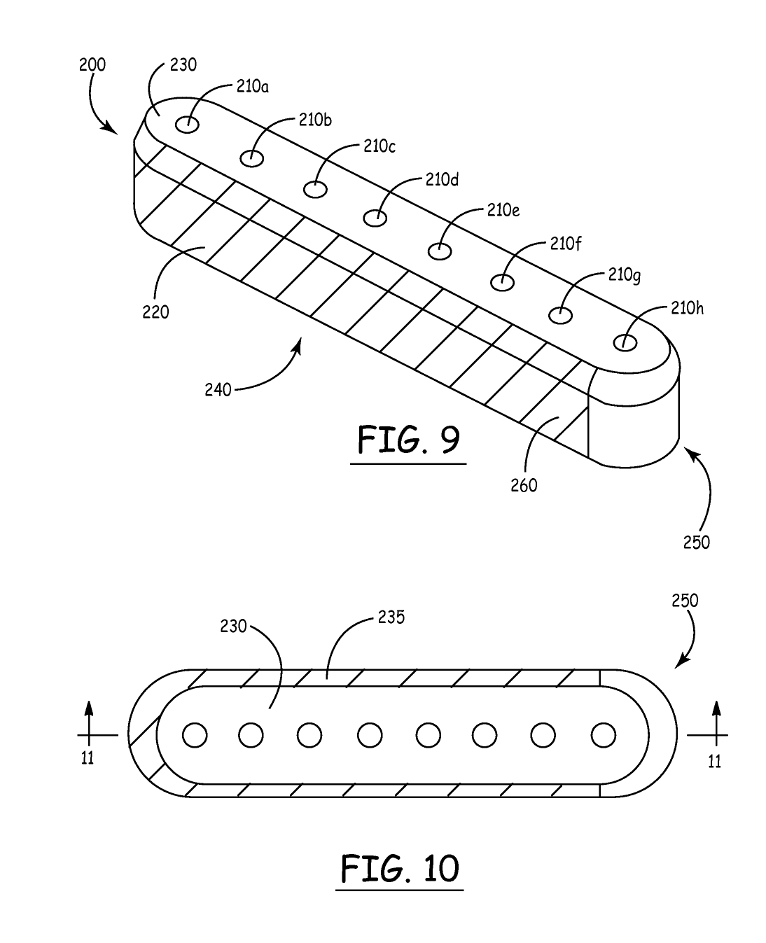

Referring now to FIGS. 9-12, a capacitor 200 according to various embodiments of the present disclosure is illustrated. The capacitor 200 includes an outer diameter portion 220 that may substantially surround the capacitor 200, a top portion 230 and bottom portion 240. A chamfer 235 can be formed on the top portion 230 of capacitor 200. The chamfer 235 will bias the placement of a solder bead or other conductive adhesive such that proper placement of the conductive adhesive proximate the ferrule 206 is assured during the assembly process. A plurality of apertures or feedthrough holes 210a-210h may extend completely through the body of the capacitor 200 to provide an opening between top portion 230 and bottom portion 240. As best illustrated in FIG. 11, inner diameter portion or portions 225a-225h are present in the capacitor 200, and, thus, define the plurality of apertures 210. The outer diameter portion 220 and inner diameter portion 225 are each connected to one of the two sets of electrode plates that comprise the capacitor 200 and are electrically isolated from one another. In an exemplary assembled capacitor feedthrough assembly, the outer diameter portion 220 is electrically coupled to the ferrule 206 and the inner diameter portion 225 is coupled to the terminal pins 205a-205h.

In various exemplary embodiments of the present disclosure, the outer and inner diameter portions 220, 225 of capacitor 200 are coated with a conductive termination material 260. Termination material 260 electrically couples one of the two sets of the electrode plates that form the capacitor with the outer diameter portion 220. Similarly, termination material 260 electrically couples the other one of the two sets of the electrode plates that form the capacitor with the inner diameter portion 225.

Arcing between the unfiltered terminal pin 205U and the outer diameter portion 220 of the capacitor 200 can occur in the presence of the high voltage associated with the feedthrough assembly 202. As described above, sleeve 282 may be included on support structure 280 to assist in the isolation of the unfiltered pin 205U from capacitor 200. Inclusion of the sleeve 282 on support structure 280, however, can increase the manufacturing complexity and cost of feedthrough assembly 202.

In a typical capacitor, the termination material 260 extends along the full length of the inner and outer diameter portions of the capacitor 200. The exemplary capacitor 200 illustrated in FIGS. 7-12, however, includes an unterminated portion 250 on the outer diameter portion 220. The unterminated portion 250 of the capacitor 200 is placed proximate the unfiltered terminal pin 205U in the assembled multipolar feedthrough assembly 202 of FIGS. 8 and 9. In this construction, capacitor 200 inhibits high voltage arcing between the capacitor 200 and unfiltered terminal pin 205U, even in the absence of sleeve 282 on unfiltered terminal pin 205U.

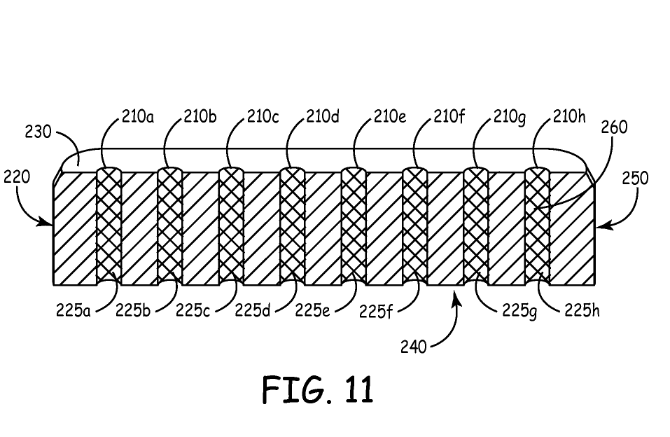

Referring now to FIG. 12, capacitor 200 can include two sets of electrode plates 259a, 259b embedded in spaced relation within an insulative substrate or base. One set of the electrode plates 259a is electrically connected to inner diameter portion 225, e.g., with a termination material. The other or second set of electrode plates 259b is electrically coupled, e.g., with a termination material, to an outer diameter portion 220 of capacitor 200. In various exemplary embodiments, the second set of electrode plates 259b can be absent from a substrate portion 255 of the capacitor 200 proximate the unterminated portion 250. The absence of the second set of electrode plates 259b from the substrate portion 255 can further inhibit high voltage arcing between the capacitor 200 and unfiltered terminal pin 205U in the assembled multipolar feedthrough assembly 202.

In various exemplary embodiments of the present disclosure, the unterminated portion 250 of capacitor 200 can be coated with a non-conductive coating, such as a non-conductive epoxy, polymer or other material. Furthermore, in various exemplary embodiments of the present disclosure, the unterminated portion 250 extends from the top portion 230 to the bottom portion 240 of the capacitor 200. In other embodiments, the unterminated portion 250 is limited to a portion of the distance between the top portion 230 and bottom portion 240 of capacitor 200. The inclusion of the unterminated portion 250, even if limited to a portion of the distance between the top portion 230 and bottom portion 240, eliminates the need for, or increases the effectiveness of, the sleeve 282 on support structure 280 in isolating the unfiltered pin 205U from capacitor 200.

FIG. 13 is an exploded view of an implantable medical device (e.g., a pulse generator) 450 coupled to a connector block 451 and a lead 452 by way of an extension 454. The proximal portion of extension 454 comprises a connector 456 configured to be received or plugged into connector block 451, and the distal end of extension 454 likewise comprises a connector 458 including internal electrical contacts 460 configured to receive the proximal end of lead 452 having electrical contacts 462 thereon. The distal end of lead 452 includes distal electrodes 464, which can deliver electrical pulses to target areas in a patient's body (or sense signals generated in the patient's body, e.g., cardiac signals).

After a capacitor 200 has been attached to feedthrough assembly 202 in the manner described above, assembly 202 can be welded to the housing of an implantable medical device 450 as shown in FIG. 14. Medical device 450 comprises a container 452 (e.g. titanium or other biocompatible material) having an aperture 454 therein through which feedthrough assembly 202 is disposed. As can be seen, each terminal pin in array 205 has been trimmed and is electrically connected to circuitry 456 of device 450 via a plurality of connective wires 458 (e.g., gold), which can be coupled to terminal pin array 205 by wire bonding, laser ribbon bonding, or the like. After installation, feedthrough assembly 202 and capacitor 200 collectively function to permit the transmission of relatively low frequency electrical signals along the terminal pins in array 205 to circuitry 456 while shunting undesired high frequency EMI signals to container 452 of device 450.

The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A filtered feedthrough assembly, comprising:
a ferrule;
a capacitor arranged within the ferrule, the capacitor having a top portion, a bottom portion, an outer diameter portion and an inner diameter portion, wherein the inner diameter portion defines at least one aperture extending from the top portion to the bottom portion, the capacitor including a plurality of conductive plates;
an outer diameter termination material applied to the outer diameter portion of the capacitor, the outer diameter termination material electrically coupling a first subset of the plurality of conductive plates;
an inner diameter termination material applied to the inner diameter portion of the capacitor, the inner diameter termination material electrically coupling a second subset of the plurality of conductive plates;
at least one filtered terminal pin extending through the at least one aperture and electrically coupled to the inner diameter portion of the capacitor; and
at least one unfiltered terminal pin extending through the ferrule, wherein the outer diameter portion of the capacitor includes an unterminated portion proximate the at least one unfiltered terminal pin.

2. The filtered feedthrough assembly of claim 1, wherein the unterminated portion includes a non-conductive coating.

3. The filtered feedthrough assembly of claim 2, wherein the non-conductive coating comprises a non-conductive epoxy, a non-conductive polymer or a combination thereof.

4. The filtered feedthrough assembly of claim 2, wherein the unterminated portion extends from the top portion to the bottom portion of the capacitor.

5. The filtered feedthrough assembly of claim 2, further comprising a support structure including a sleeve, wherein the at least one unfiltered terminal pin extends through the sleeve.

6. The filtered feedthrough assembly of claim 1, wherein the unterminated portion extends from the top portion to the bottom portion of the capacitor.

7. The filtered feedthrough assembly of claim 1, further comprising a support structure including a sleeve, wherein the at least one unfiltered terminal pin extends through the sleeve.

8. The filtered feedthrough assembly of claim 1, wherein the first subset of the plurality of conductive plates are absent from a substrate portion proximate the unterminated portion.

9. A method of assembling a filtered feedthrough assembly, comprising:
providing a capacitor having a top portion, a bottom portion, an outer diameter portion and an inner diameter portion, the capacitor including a plurality of conductive plates, wherein:
the inner diameter portion defines at least one aperture extending from the top portion to the bottom portion;
an outer diameter termination material on the outer diameter portion of the capacitor electrically couples a first subset of the plurality of conductive plates, the outer diameter termination material being absent from an unterminated portion of the outer diameter portion of the capacitor; and
an inner diameter termination material applied to the inner diameter portion of the capacitor, the inner diameter termination material electrically coupling a second subset of the plurality of conductive plates;
inserting at least one filtered terminal pin and at least one unfiltered terminal pin within a ferrule; and
fixedly securing the capacitor within the ferrule such that the at least one filtered terminal pin extends through the at least one aperture, the at least one unfiltered terminal pin being proximate to the unterminated portion of the outer diameter portion of the capacitor.

10. The method of claim 9, wherein the unterminated portion includes a non-conductive coating.

11. The method of claim 10, wherein the non-conductive coating comprises a non-conductive epoxy, a non-conductive polymer or a combination thereof.

12. The method of claim 10, wherein the unterminated portion extends from the top portion to the bottom portion of the capacitor.

13. The method of claim 10, further comprising inserting a support structure within the ferrule, the support structure including a sleeve, wherein the at least one unfiltered terminal pin extends through the sleeve.

14. The method of claim 9, wherein the unterminated portion extends from the top portion to the bottom portion of the capacitor.

15. The method of claim 9, further comprising inserting a support structure within the ferrule, the support structure including a sleeve, wherein the at least one unfiltered terminal pin extends through the sleeve.

16. The method of claim 9, wherein the first subset of the plurality of conductive plates are absent from a substrate portion proximate the unterminated portion.

17. A capacitor assembly for use in a filtered feedthrough for an implantable medical device, comprising:
a capacitor having a top portion, a bottom portion, an outer diameter portion and an inner diameter portion, wherein the inner diameter portion defines at least one aperture extending from the top portion to the bottom portion, the capacitor including a plurality of conductive plates;
an outer diameter termination material applied to the outer diameter portion of the capacitor, the outer diameter termination material electrically coupling a first subset of the plurality of conductive plates, the outer diameter termination material being absent from an unterminated portion of the outer diameter portion of the capacitor;
an inner diameter termination material applied to the inner diameter portion of the capacitor, the inner diameter termination material electrically coupling a second subset of the plurality of conductive plates; and
a non-conductive coating on the unterminated portion of the outer diameter portion of the capacitor.

18. The capacitor assembly of claim 17, wherein the non-conductive coating comprises a non-conductive epoxy, a non-conductive polymer or a combination thereof.

19. The capacitor assembly of claim 17, wherein the unterminated portion extends from the top portion to the bottom portion of the capacitor.

20. The capacitor assembly of claim 17, wherein the first subset of the plurality of conductive plates are absent from a substrate portion proximate the unterminated portion.
